(19) United States
(12) Patent Application Publication
(10) Pub. No.: US 2014/0164110 A1
(43) Pub. Date: Jun. 12, 2014

(54) SYSTEM AND METHOD FOR MEDIA SPEND ATTACHED TO NETWORK OFFERS

(71) Applicants: Kenneth J. KALB, Solana Beach, CA (US); Mark H. SCHWARTZ, Livonia, MI (US); Thomas H. BUSCHER, Los Angeles, CA (US)

(72) Inventors: Kenneth J. KALB, Solana Beach, CA (US); Mark H. SCHWARTZ, Livonia, MI (US); Thomas H. BUSCHER, Los Angeles, CA (US)

(21) Appl. No.: 13/946,904

(22) Filed: Jul. 19, 2013

Related U.S. Application Data
(63) Continuation-in-part of application No. 13/231,914, filed on Sep. 13, 2011.
Application No. 13/231,914 is a continuation-in-part of application No. 12/009,280, filed on Jan. 17, 2008, now Pat. No. 8,090,613.

(51) Int. Cl. G06Q 30/02

(52) U.S. Cl. CPC G06Q 30/0255
USPC 705/14.53

(57) ABSTRACT

The system provides a method and apparatus for attaching media spend to an offer to be published by one or more publishers. In one embodiment the system allows an offering publisher to attach media spend to an offer that is available to one or more receiving publishers, such as through a syndicate network. The attached media spend may include an agreement to buy advertising space on the publishing platform of a receiving publisher. In one embodiment, the attached media spend may allow a receiving publisher to have the right to advertising space on the publishing platform of the offering publisher. In one embodiment, the attached media spend is a combination of an offer to buy space of a receiving publisher and to provide space to the receiving publisher on the publishing platform of the offering publisher.

This patent application is a continuation-in-part of U.S. patent application Ser. No. 13/231,914 filed Sep. 13, 2011, which is a continuation-in-part of U.S. patent application Ser. No. 12/009,280 filed on Jan. 17, 2008 (now U.S. Pat. No. 8,090,613, all of which are incorporated by reference herein in their entirety.

### BACKGROUND OF THE SYSTEM

The advent of the Internet and other digital platforms has had a significant impact on the economic model of so called “legacy” media, which includes most off-line media such as newspapers, radio, television, magazines, direct mail, and the like. Legacy media has traditionally been an advertising driven model, with income generated through the sale of ads in publications. As the Internet has prospered, advertising has shifted to the digital world at the expense of off-line publications. The growth in internet advertising has had a negative effect on legacy media. Many newspapers, magazines, and radio stations are facing a budgetary crisis due to a loss of advertising revenues. One reason that legacy media has lost market share i advertising is the fact that these off-line media does not provide real accountability for advertising campaign performance. Because of this deficiency, advertisers are spending their marketing dollars in channels with knowable performance.

Publishers of legacy media have adapted to the new paradigm in some cases by adding digital online versions of their publications. However, not all of the users of off-line media will take advantage of the on-line content of a legacy publisher. In addition, there is a difficulty in acquiring known and exploitable customers to the on-line and off-line publications of legacy publishers. In addition, publishers have failed to become participatory in the revenue from advertising placed in their publications.

Even for on-line participants, there has been a reliance on outdated models of measuring effectiveness of advertising and other customer acquisition approaches. Further, there has been little to no incentive to cooperate with other publishers, whether on-line or off-line, to maximize customer acquisition opportunities and revenue generation.

### SUMMARY OF THE SYSTEM

The system provides a method and apparatus for attaching media spend to an offer to be published by one or more publishers. In one embodiment the system allows an offering publisher to attach media spend to an offer that is available to one or more receiving publishers, such as through a syndicate network. The attached media spend may include an agreement to buy advertising space on the publishing platform of a receiving publisher. In one embodiment, the attached media spend may allow a receiving publisher to have the right to advertising space on the publishing platform of the offering publisher. In one embodiment, the attached media spend is a combination of an offer to buy space of a receiving publisher and to provide space to the receiving publisher on the publishing platform of the offering publisher.

In one embodiment, the system may be part of a system and method for dynamic off-line ad campaign management and optimization makes it possible to analyze the history of responses to a multitude of off-line advertisements and/or offers, and based on the garnered customer habits, an individual customer's preferences for various activities and products is analyzed and then compared jointly with that of other customers. This process allows accurate classification of each customer. The system then provides ever improving statistical analysis of the likes and dislikes of customers as their history of participation with the system increases. In other embodiments, the syndication network may be part of a more traditional advertising environment.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates an embodiment of the syndication network.

FIG. 2 illustrates an embodiment of an accountable campaign system.

FIG. 3 is a flow diagram illustrating an offer made to the syndication network with attached media spend in an embodiment of the system.

FIG. 4 is a flow diagram illustrating the selection of an offer with attached media spend from the syndication network in an embodiment of the system.

FIG. 5 is an example computer environment for implementing the system.

FIG. 6 is a flow diagram illustrating automated attachment of media spend in one embodiment of the system.

FIG. 7 is a flow diagram illustrating advertisement arbitrage in one embodiment of the system.

### DETAILED DESCRIPTION OF THE SYSTEM

The following description is merely exemplary in nature and is not intended to limit the present disclosure, application, or uses. It should be understood that throughout the drawings, corresponding reference numerals indicate like or corresponding parts and features.

The system can be advantageous to publishers, to financial institutions, to credit card companies, to manufacturers who are making products which they need to promote, vendors who need to advertise their products or services, and any advertising body, either for a department within a large corporation, or a standalone advertising agency creating campaigns for a multitude of disparate clients companies. These organizations are highly motivated to achieve return on their financial investment in marketing and advertising. Their advertising spending therefore needs to be evaluated in terms of its impact on customer acquisition. The impact thus measured will then allow quantitative measurement of the performance of each advertisement and make it possible based on this information to maximize logistical and economic efficiencies of the overall campaign. These organizations also have a strong desire to acquire customers.

The system provides a customer acquisition, revenue generating, and advertising accountability platform. The system contemplates a plurality of publishers, vendors, advertisers, and distributors in a syndication network. At any given moment, there are a plurality of offers available to members of the network. These offers can be from one or more members of the syndication network itself, or from third parties.

In the example herein, an “offering publisher” introduces an offer to the syndicate. One or more “receiving publishers” accept the offer and publish it on one or more of their publishing platforms. The offer contemplates a consumer or customer response.

The response may be a purchase, a request for information, a website visit, or some other response. The consumer can respond using smartphones, PDA's tablet and pad based computing devices, Google Glass, telephones, browser enabled devices, and the like. When a consumer responds, the system tallies that response and uses it to analyze the effectiveness of the offer. The system collects all the information that is available in the response from the consumer, including the timing of the response, the avenue of the response, the on-line or off-line format from which the response was generated, and, where available, registered user information. As noted above, the system may be implemented in a system where responders are (or become upon responding) registered users, or it can be implemented where none of the responders are registered users, or it can be a hybrid of registered and unregistered users.

In one embodiment, the system is implemented for both on-line and off-line environments. Any syndicate member may have off-line and/or on-line capabilities in a combined system. In other embodiments, the system may be implemented exclusively on-line or exclusively off-line.

One of the advantages of the system is the use of analytics to provide accountability for each ad or deal or offer implemented using the system. This provides the data to drive metrics associated with the offers and even the publishers so that intelligent and automated decisions may be made regarding syndication of offers and sharing of revenue.

Network Syndicate Structure

In one embodiment, the system contemplates a network of publishers in a network syndicate, where the publishers participate in a shared campaign management system. The following is an example of such a network syndicate.

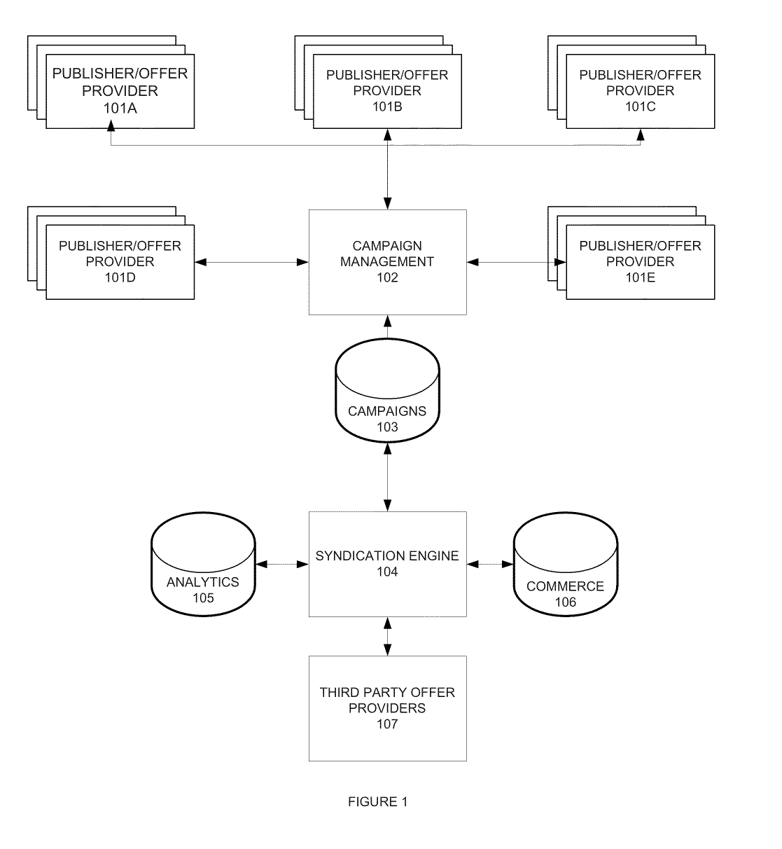

FIG. 1 illustrates a network syndicate structure in an embodiment of the system. The syndication network in one embodiment comprises a plurality of syndicate members 101A-101E of FIG. 1. In the example of FIG. 1, each syndicate member 101A-101E is shown as both a publisher and offer provider. However, the syndicate members may be one or the other. For example, a syndicate member may be solely a publisher and rely on others to generate offers that may be published by the publisher.

In other instances, the syndicate member may be solely an offer provider who relies on publishers to disseminate its offers. In addition, there may be third party offer providers 107 that are not necessarily part of the syndicate, but whose offers may be used by the syndicate and introduced by the syndicate management. Further, any syndicate member may introduce an offer from a third party source to the network.

The syndicate members are in communication with campaign management 102. Campaign management 102 is used to maximize campaign effectiveness through monitoring of a campaign to evaluate effectiveness of offers. This monitoring can take place in near real-time or on any desired schedule, so that the system becomes a close looped system that provides accountability to the offer campaign.

As can be appreciated, campaign management is applicable to various advertising campaign managers, including, but not limited to, manufacturers, goods and service providers, advertising departments, and advertising agencies. Essentially all kinds of merchants can make use of the invention to promote their particular business.

A syndication engine 104 is coupled to the campaign manager and to the analytics engine 105, commerce module 106, and third party offer providers 107. The syndication engine is used to manage the sharing and distribution of offers in the syndication network and to manage accounting and other relevant data associated with shared offers. The analytics engine 105 is used to analyze the performance of each offer in all media channels in which it may be published, and to provide metrics that can guide future offer selection by the syndicate members. The commerce module 106 is used to handle fulfillment and other transactional requirements associated with the offers in the syndication network.

Analytics System

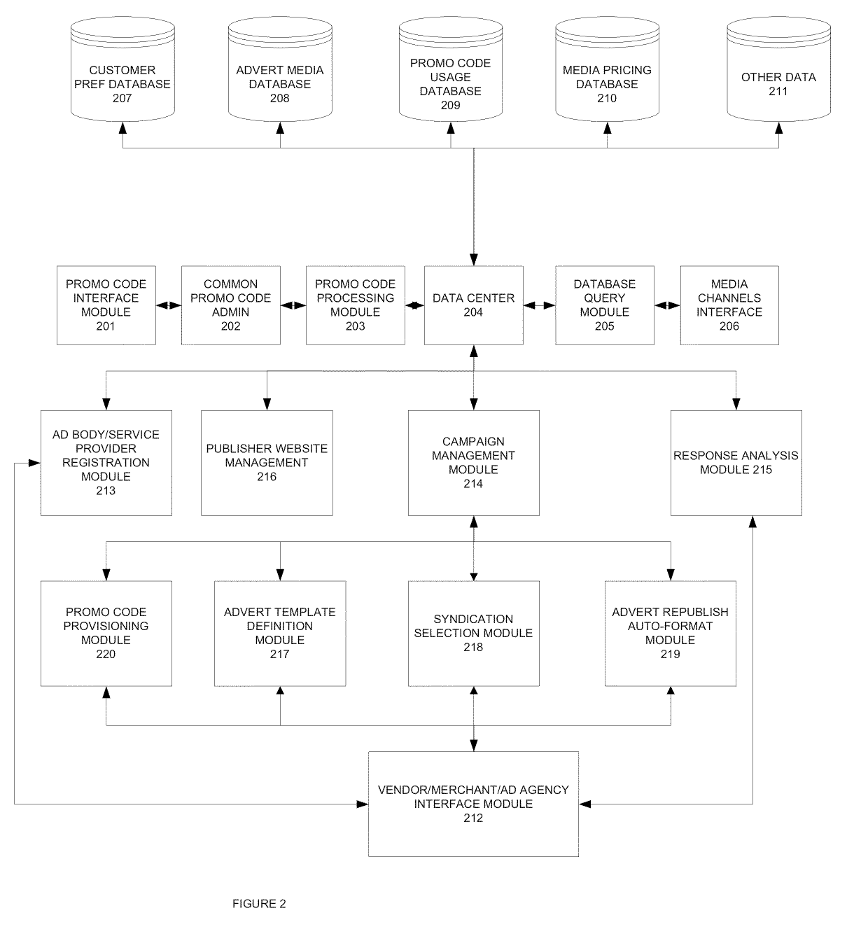

In one embodiment, the system is used as part of an analytics system such as is described in U.S. Pat. No. 8,090,613 which is incorporated by reference herein in its entirety. Such a system allows the modification of campaigns during the life of the campaign to optimize the effectiveness of the campaign. An example of such a dynamic analytics system is illustrated in FIG. 2. FIG. 2 is a block diagram illustrating the promo code embodiment of the system. The embodiment of the system includes a promo code interface module 201, a media channels interface module 202, a vendor/merchant or advertising body user interface module 203, a common promo code administrations interface module 204, a promo code processing module 205, a database query processing module 206, a good or service provider or advertising body registration module 207, an advertising campaign management module 208, a response analysis module 209, a data center 210 including a customer preference database 211, an advert media database 212, a media pricing database 213, and a promo codes usage database 214 among others, a promo code provisioning module 215, and a publisher website 216.

The system may also includes several additional modules, which make new functions possible for the cooperative publishing or syndication of advertisements. These include advert template definition capture module 217, which assists the overall system operator to collect essential information from merchants to be contained in their advertisement and associated special offer, syndication selection interface 218, which allows a source publisher to set parameters for other publishers that intend to syndicate the advertisement, and advert republish auto-format module 219, which allows any member publisher in the network to selected offers to republish the on their website and promote using their own traditional media channels.

The present disclosure describes various embodiments of a system and method for improved advertising using embedded surveys and ad monitoring, analytical analysis of ad effectiveness, all followed by improved performance feedback and especially centralized means to manage and control and to optimize the advertising campaign. In all its various embodiments the system can perform control of advertisement placement and scheduling for maximum efficiency of an off-line and/or on-line campaign while minimizing required efforts from a campaign manager. The system can be implemented within a single computer or be distributed over a number of devices.

It is appreciated that the modules and data structures shown may be combined and/or further partitioned to similarly perform campaign management. Various embodiments of campaign management and optimization methods and systems include alternative implementations and combinations of the above described elements as will be described in more detail below.

The vendor/merchant or advertising body user interface module 213 serves for configuration, and control of operation and display of the system. The advertising body user interface module 213 is used to provide input to a good or service provider or an advertising body registration module 213, an advertising campaign management module 214, and a response analysis module 214 (it should be noted that the response analysis module may also perform in real-time, near-real time, or in some other asynchronous manner where responses are received after offers are run and the system is able to associate responses to particular off-line channels as well as to particular time periods of ad presentation) These modules operate and interact with the central registry of information contained within data center 204. The data center 204 comprises a customer preference database 207, an advert media database 208, a media pricing database 210, a promo code usage database 209, and other database 211, among other databases.

The data in the customer preference database 207 is created in part by interactive collection from a customer that responds to offers and/or registers with one or more of the syndicate members. Additional information in the customer preference database 207 is accumulated over time using the system and tracking usage and response patterns of customers. This data is formed by the cumulative history of responses to offers.

The system of the present disclosure makes it convenient for the advertiser and/or publisher to provide offers to customers in order to increase the likelihood of their conversion. Conversion is the process by which a viewer purchases or subscribes to an advertiser's product or service. The word conversion describes how an advertiser might first encounter a viewer as a sales lead and then the lead would “convert” to becoming a customer by buying a product.

Creative advertisement or creative is a term used to describe the advertisement being used to promote or sell a product or service. The creative or advert media database 208 contains actual viewable or listenable content. The media database 208 content includes digital copies of the offers which will be published in a magazine, newspaper, or even roadside billboard displays. It also includes sound files in a digital format such as way, or mp3 files for play on radio commercials. Multi-media ads created for example for broadcast television, cable TV, and viewing in theaters before movies, can be stored in a number of formats in the digital database including among others, divx, avi, mpeg4, mpg, and wmv type files. The system uses the files stored in the media database to allow quick creative review by decision makers while using the analytical information to adjust the scheduling and geographical distribution of ads. The easy and organized access to review capability while simultaneously reviewing the performance data will allow creative design and also management teams, when collaborating on overall advertising strategies or adjusting demographic targets, to better predict the way to design an ad or position it in the marketplace to get the highest performance.

Media buy refers to the buying of advertising space from a company operating media properties such as TV, radio, newspapers, magazines and billboards or outdoor kiosks. The cost of a media buy varies depending on (1) the specific media property on which the buyer wants to advertise, (2) the size of the advertising campaign, (3) the specific times at which the advertisements are to be displayed, and (4) other specific features of the advertising campaign. The media pricing database 210 is built by entering pricing information either manually or automatically collected from the various media channels. Each media channel can have different means for calculating their pricing of an advertisement. Magazines for example run on a monthly basis and charge prices depending on ad size and position. Television commercial prices depend on length, time of day, and are related to the popularity of the show or program during which the spot is aired. The pricing database 210 contains all rules and formulas necessary to make complete price calculations for each media channel, and upon campaign configuration by the operator or user, is used to calculate the total cost for each particular ad included in the campaign along with overall campaign cost.

In one embodiment, the customer will be provided with what is termed here a “promo code”. In one embodiment, promo codes are to be used by the customer at web sites, such as advertiser or publisher web sites. The web site can be accessed by any web enabled device, including computers, PDA's, web enabled cell phones, Smart-Phones, and the like. In implementing a promo code, the publisher of the advert provides a website to which the viewer is invited to navigate. This web site may be a web site of the publisher, of the provider of the goods or services being advertised, or by a third party that implements the system on behalf of participating parties. Once at the web site, the customers will be directed or linked to a promotions web page which solicits the login of the user. Then, upon entry of the promo code the customer has full access to the offered special promotions. Examples of CTAs that can be used by the system include, but are not limited to, short codes, email, SEM, SEO, a web site (publisher, merchant, third party, etc), social media site (Facebook, Twitter, and the like), telephone number, RFID chip, bar code, QR (Quick Response) codes and the like, wireless mechanisms such as RFID codes and the like, and/or sound based response mechanisms such as audio response and the like, and image based response mechanisms such as video or still image transmission.

The promo code usage database 209 contains a complete and current history of which promo codes are assigned to each vendor and offer. This provisioning information is used to prevent duplication of assignment and also permit accurate analysis of the viewer or customer responses.

A media interface module 206 makes communication possible with all the various media channels in order to automatically perform various functions including, among others, gathering the pricing information from the disparate channels. In a preferred embodiment, update of pricing information is an automated process whereby media channels send any changes in pricing as they are made directly to the media interface 206 to the system

A database query processing module 205 is shown in FIG. 2 as gathering data from the media channels for storage in the system. The query processing module 205 also performs all queries that are necessary to create an ad campaign or to assist in the response monitoring and analysis. A promo code interface module 201 provides the ability to capture the customer responses including among others, text messages and keywords sent in response to a particular short code in an advertisement. A promo code processing module 203 takes the captured text messages and keywords and enters them into the appropriate fields in the customer preference database 207 and other databases contained in the system that are necessary to keep track of the volume, timing, and location of each customer response and permit the accurate combined analysis of all the received customer responses.

A campaign management module 214 comprises a number of submodules including a promo code provisioning module 220, an advert template definition module 217, a syndication selection module 218, and advert republish and autoformat module 219.

Daily Deal

In the description herein, an offer is a means to draw a response from a consumer of the offer. Such offers can include, but are not limited to, advertisements, discounts, coupons, membership points, access to events or services, and the like. One type of offer that can be used in the present system is known as a “Daily Deal” (DD). Often a DD will require that the consumer purchase the DD offer, typically at a meaningful discount, in return for goods or services valued at greater than the amount paid for the DD. The behavior of the customer in purchasing the DD allows not only accountability for the effectiveness of offers, but immediate financial benefit to the merchant and publisher as well.

An example of a DD is the offer of a coupon that is worth, for example, $50.00 when used at a particular merchant for goods or services. However, the customer only pays, for example, $25.00 for the coupon. When the customer redeems the coupon by using it at the merchant, it is as if the customer gets $50.00 worth of goods or services for only $25.00.

Each offer has associated with it a plurality of metrics and meta-data that allows network members to determine the value of the offer to themselves. For example, if the offer is a DD, the meta-data would include deal terms for using the offer (e.g. the cost to the consumer to purchase the DD, the amount that goes to the provider of the goods or services associated with the DD, the amount that goes to the publisher of the DD, and the amount that goes to the syndication network member that originally offered the DD to the network). Other meta-data may include the historical conversion rate of the offer, the demographics of purchasers of the offer, the conversion rate of the offer per publishing platform (e.g. for radio, television, print, on-line, and the like). The meta-data could also include temporal related data if the performance of the offer has historically had a temporal based correlation or relationship.

Each offer includes a customizable Call-To-Action (CTA) that allows the consumer to respond to the offer (e.g by purchasing the DD). Because each publisher has its own associated CTA, the system can track the identity of the publisher of the offer to which a consumer is responding. Examples of CTAs that can be used by the system include, but are not limited to, short codes, email, SEM, SEO, a web site (publisher, merchant, third party, etc), social media site (Facebook, Twitter, and the like), telephone number, RFID chip, bar code, QR (Quick Response) codes and the like, wireless mechanisms such as RFID codes and the like, and/or sound based response mechanisms such as audio response and the like, and image based response mechanisms such as video or still image transmission.

Deal Offer to Syndicate

In one embodiment, consider the situation where a merchant proposes a daily deal with a publisher who is a member of the syndicate. The analytics system may be used to generate one or more ad templates for the campaign, including print, television, radio, on-line, and other media. The DD is then made available to the syndicate members. The use of templates allows the system to meet the display needs of any of the publishers in the syndicate, whatever media they may choose. One or more publishers in the syndication network may then choose to participate in that DD and publish it themselves. This may be when the publisher does not have its own daily deal for that day or may believe that the source publisher has a better DD than the network publisher has available. The system also allows local publishers (and merchants) to have national exposure opportunities when the DD is used by other syndicate members.

By sharing a DD in a syndicate, each DD can generate greater revenue than if it were limited to a single publisher. In addition, by providing both on-line and off-line publishing opportunities, the system creates exposure to customers that would otherwise be unreachable. The system provides a variety of economic models associated with each DD. For example, a syndicate member who takes the DD may receive a certain revenue share of the DD for all sales. In other embodiments, the syndicate member is offered a revenue share for only those customers that respond to the offer in that members publication. In other instances, the publisher may receive accelerator payments if a certain number of the DD are converted or sold.

Because the system provides for unique promo codes and calls-to-action for each publisher, the system has the ability to provide accurate accounting of revenue sharing and DD performance. The analytics system also provides the ability to capture and generate meaningful metrics associated with any individual DD as well as entire categories of DDs so that syndicate members can use the marketplace of DDs more effectively. It should be noted that any individual publisher may themselves have one or more on-line and off-line media in which to publish the DD. The publisher can choose the appropriate template for each publishing platform. In other cases, the publisher may choose a different DD for each publishing platform based on associated metrics of the DD.

Offer with Media Spend

When an offering publisher presents a DD to the network, the offering publisher is hoping to increase the revenue, conversion rate, and click-through rate of the DD by expanding its availability and advertising. In this system, to encourage acceptance of the DD by a receiving publisher, the offering publisher attaches media spend to the DD.

Each DD has associated metadata that describes metrics and parameters associated with the DD, including revenue sharing and other transaction aspects of the DD offer. This system adds additional parameters to the DD offer in the form of media spend. The offering publisher may offer to pay one or more receiving publishers for displaying the DD on their publishing platforms.

The media spend may take one or more of several forms. For example, the media spend may promise the receiving publisher an amount per some number of expected views (e.g. a cost-per-thousand) for an online presentation. Many online publishers have rates for certain ads, such as banner ads. The media spend could cover or supplement the cost of running the offer on the online site. In other instances, the media spend could cover radio advertising, TV advertising, print advertising, text message advertising, direct mail, posters, or any other suitable offer platform.

FIG. 3 is a flow diagram illustrating the generation of an offer with attached media spend in an embodiment of the system. At step 301 the offering publisher selects an offer that it wishes to offer to the syndicate. At step 302 the offering publisher selects a publishing platform on which it desires to have the offer published. The platform could be online, print, radio, television, and the like. The offering publisher chooses an appropriate form of spend at this point for the attached media spend (e.g. $ per subscriber, per thousand, per click, and the like)

At step 303 it is determined if there is a required format for the DD to be used by the receiving publisher on the platform. For example, if the platform is a newspaper, the offering publisher may require a certain size, placement, section, or other characteristic of the offer when it is published (e.g. a quarter page in the sports section). If it is an online ad, the offering publisher may require it be an animated banner ad of a certain size, for example, If there is a required format, the offering publisher defines the format at step 304.

If there is no required format at step 303, or after the format has been defined at step 304, the system proceeds to decision block 305 to determine if there is a maximum spend associated with the offered DD. For example, the offering publisher may offer $3.00 per thousand views for an online banner. However, there may be a maximum spend of, for example, $10,000.00. If there is a maximum, the system proceeds to step 306 and defines the parameters of the maximum.

After the maximum is defined, or if there is no maximum at step 305, the system proceeds to step 307 to determine if the offering publisher is offering reciprocal ad space as part of the media spend. As noted above, the receiving publisher may have the right to immediate or later space on the offering publishers platform in return for taking the DD. If so, the reciprocal ad space is defined at step 308. After the reciprocal ad space is defined at step 308, or if there is no reciprocal ad space at step 307, the system proceeds to step 309 to determine if there is another platform for which attached media spend is to be defined. If so, the system returns to step 302. If not, the offering publishers submits the DD with attached media spend at step 310.

The attached media spend can be incentive driven as well, with the spend based on conversion rates, click-throughs, registrations, and/or other performance parameters.

Acceptance Process

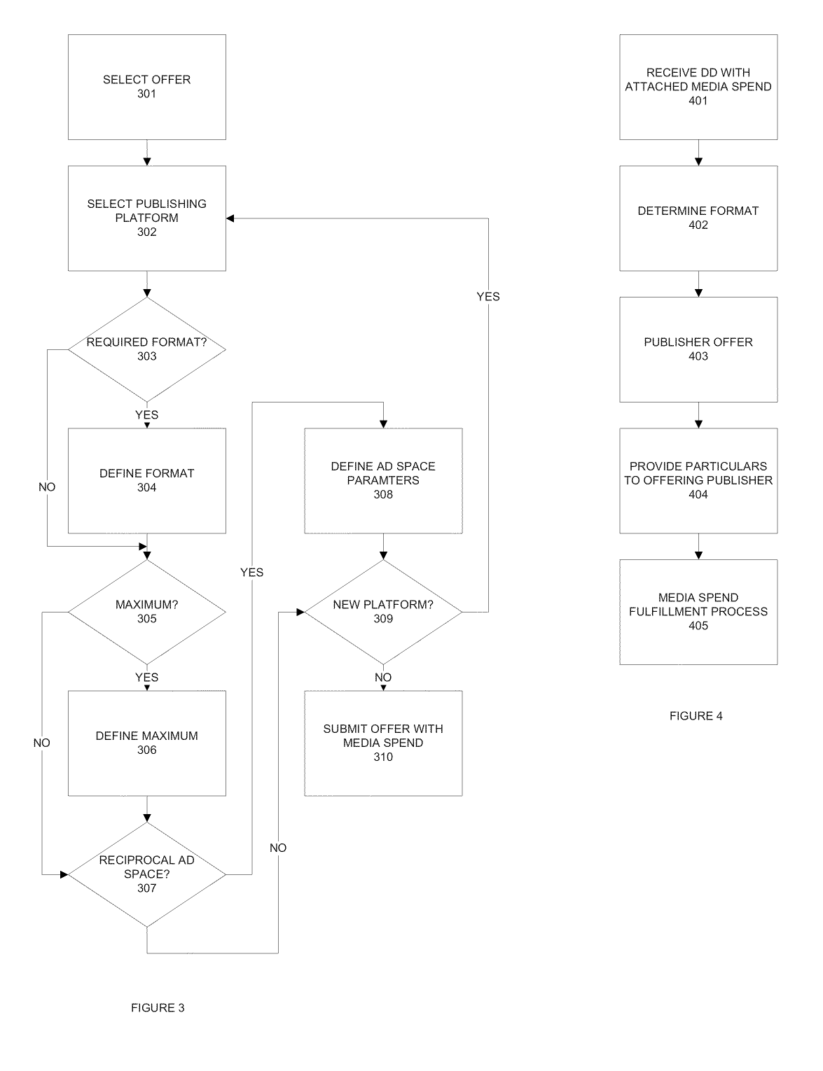

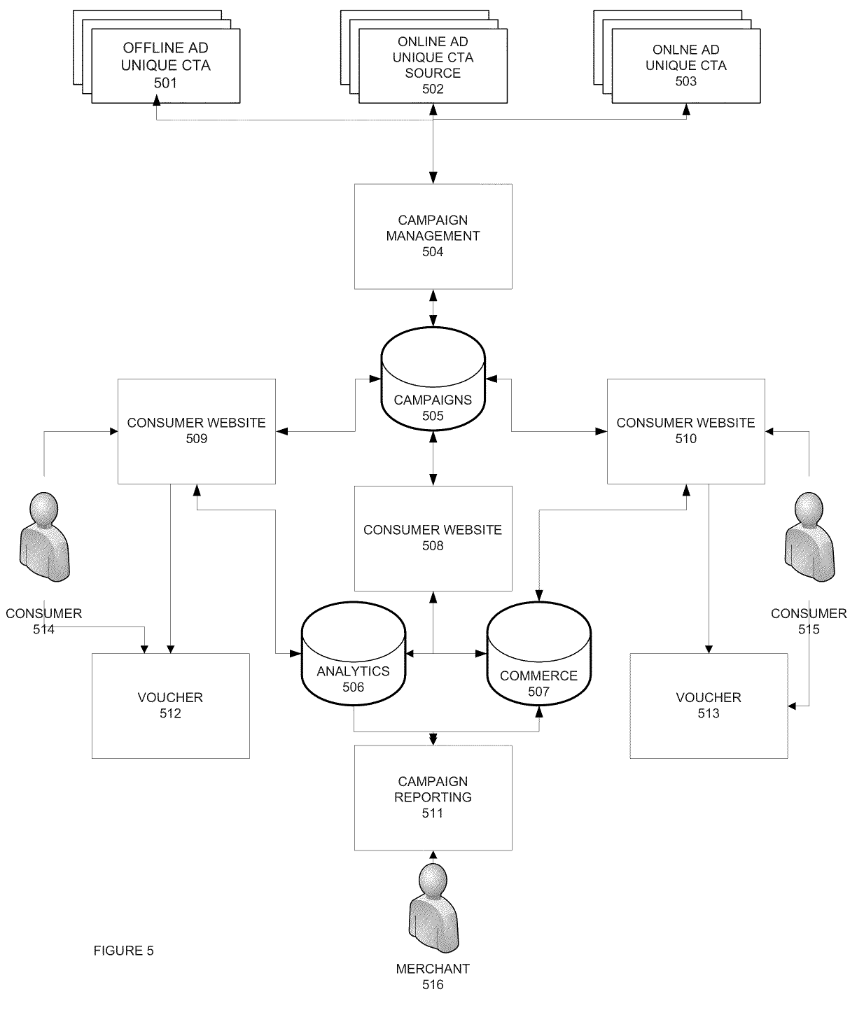

FIG. 4 is a flow diagram illustrating the operation of a receiving publisher in acquiring a DD with attached media spend in an embodiment of the system. At step 401 the receiving publisher receives the DD with media spend from the offering publisher (or via the syndicate system). At step 402 the receiving publisher determines the format for publishing on its platform. If there is a required format, the receiving publisher must provide at least that format to use the DD. However, the receiving publisher can publish the DD in a larger format if desired to maximize the return on the DD. The media spend, for example, might cover the cost of a quarter page ad in a newspaper. However, the receiving publisher is permitted to publish the DD in a full page ad if desired, using the media spend to offset at least some of that opportunity cost.

At step 403 the receiving publisher publishes the DD on its platform. At step 404 the receiving publisher provides an accounting to the offering publisher of the publishing of the DD and the number of views or other metric to determine how much of the media spend is actually owed to the receiving publisher. At step 405 the parties finalize the financial aspects of the transaction pursuant to the offer and performance.

Campaign Management

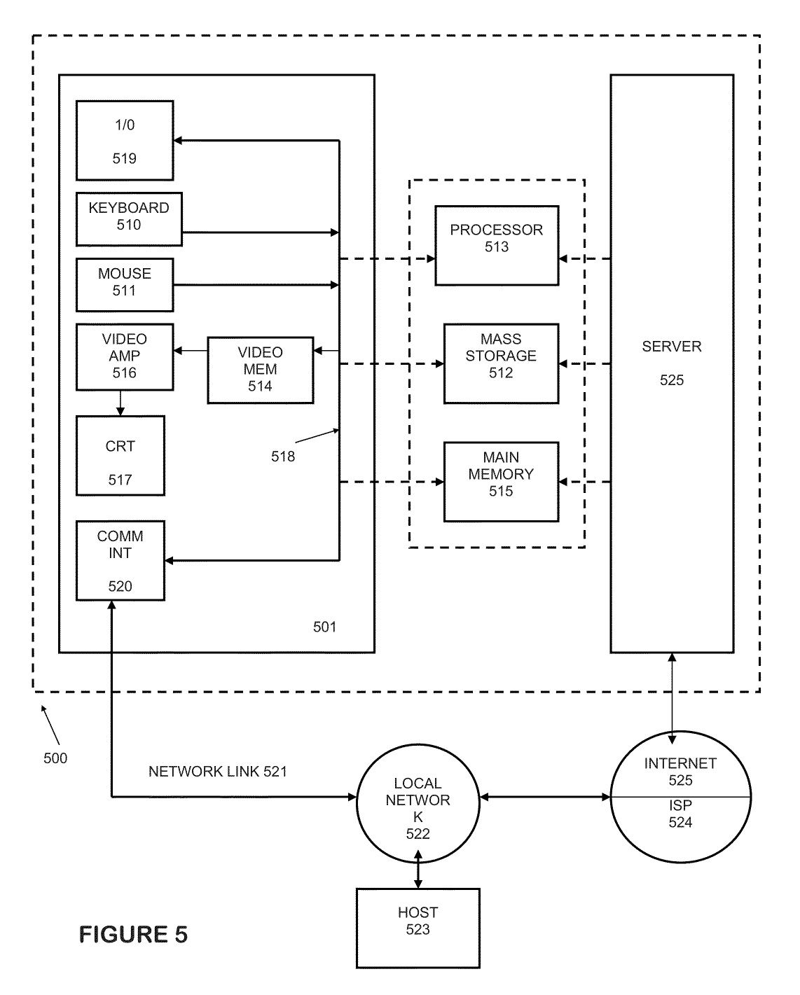

FIG. 5 illustrates the operation of a DD transaction in one embodiment of the system. In this example a merchant 516 has created a DD and provided it to source publisher 502. The source publisher has made the DD available to the network with attached media spend and publishers 501 and 503 have elected to publish the DD. In this example publisher 501 is an offline publisher while publishers 502 and 503 are online publishers. However, it is possible that each publisher has one or more online and/or offline publishing platforms for offering the DD.

Each of the publishers presents the DD as an offer with a unique CTA that allows the system to identify the publisher and the platform to which a customer (e.g. consumer 514 or consumer 515) is responding. The publishers are coupled to the system through the campaign management module 504 to the campaigns database 505. Although only a few publishers are shown in FIG. 5, the system is fully scalable and may manage any number of offers as well as any number of publishers who elect to participate in the system.

When consumer 514 elects to purchase the DD, the unique CTA directs the consumer to a consumer website 509 that is used for accepting payment and for providing some indicia (e.g. voucher 512) that is used by the consumer 514 for fulfillment of the offer with merchant 516. In some cases, the website may be the website of the publisher, or an associated website. The advantage of directing the consumer 514 to a unique instance of a website is that the publisher can acquire the customer via a required registration process during the voucher transaction. For example, if publisher 501 is a newspaper, the consumer may be required to register with the newspaper as part of the voucher acquisition process. Similarly, consumer 515 is directed to consumer website 510 (perhaps associated with or owned by publisher 503) to purchase voucher 513.

Even if the consumer is already a registered customer of the publisher, the publisher gains valuable demographic data about the customer's preferences and purchasing habits. In one embodiment, there is not only a unique CTA for each publisher and each platform, but for each type of device on which the DD appears. For example, Publisher 503 will have a unique CTA for the DD when it appears on the publishers mobile platform, tablet platform, or desktop platform. This provides additional unique information about the consumer and about the efficacy of the DD and other promotions.

Information about the voucher transactions, from any website, are forwarded to the analytics engine 506 and commerce module 507. Analytics 506 is used to evaluate the effectiveness of the offer and to determine if changes should be made to the campaign, either during the campaign itself, or in future campaigns. The commerce module 507 is used to aid in handling the financial aspects of the voucher transactions, as well as providing accounting and payments to the source publisher and receiving publisher for syndicated offers, as well as to the merchant 516 The campaign reporting module 511 provides offer statistics to the merchant who will provide the goods and/or services associated with the DD and the attached media spend.

Automated Media Spend

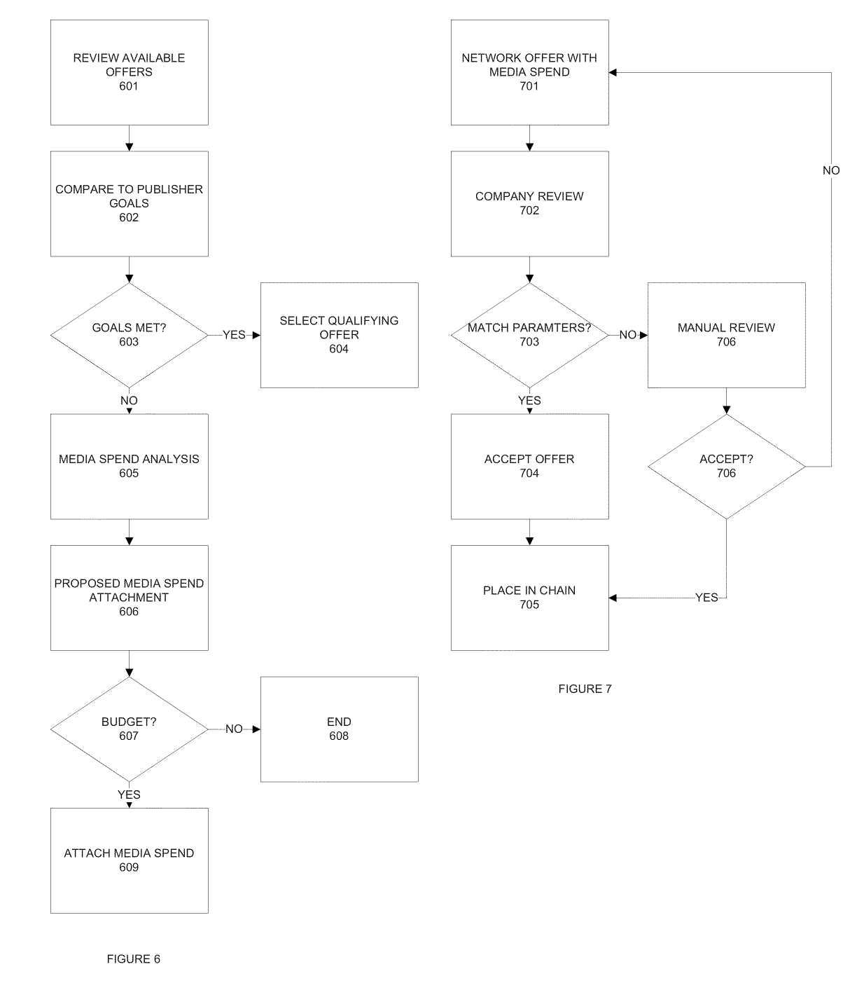

In one embodiment, the system uses historical performance data of syndicated DD offers, along with financial and customer acquisition goals to automate the generation of a DD offer with attached media spend. FIG. 6 is a flow diagram illustrating an example of automated attachment of media spend in an embodiment of the system. At step 601 a syndicate publisher reviews available offers (e.g. DD's) that the publisher may offer with attached media spend. Each DD has associated metadata that reflects the metrics of the DD based on historical performance, including conversion rates, click-throughs, registrations and the like.

At step 602 the publisher compares the metrics of each offer to the publisher goals. The goals may be set based on time of day, day of week, time of year, publishing platform, and the like. In this case, one of the goals may be customer acquisition. The system reviews the likely adoption rate by other publishers and the likely success of the offer based on that adoption rate. At decision block 603 the publisher determines if any of the available offers match the publisher's goals. If so, the system selects one or more qualifying offers at step 604.

If none of the offers match the publisher's goals, then the system proceeds to step 605 and performs media spend analysis. The media spend analysis determines if there is a media spend that could be added to one or more of the available offers that would increase the adoption rate and performance of the offer so that the publisher's goals could be met. The media spend analysis may be done on a platform by platform level, may include monetary incentives and/or reciprocal placement as described above.

At step 606 the system generates a proposed media spend attachment that will meet the goals of the publisher. At decision block 607 it is determined if the proposed media spend is within budget. If not, the system ends at step 608. If so, the system attaches the media spend to the offer and makes it available to the network.

Advertisement Arbitrage

The system has been described above with respect to an offering publisher including media spend with to receiving publishers. However, the system has equal applicability to advertisers, vendors, merchants, and the like as well. There may be an instance where a first company may want to offer or accept media spend of an advertisement of a second company because the first company believes it will benefit from the advertisement indirectly. For example, consider the case where a restaurant and a coffee shop are near each other. A traffic increase at the coffee shop may benefit the restaurant in the form of increased customers (or vice versa). The restaurant may want to subsidize (through media spend) an advertisement or other offer related to the coffee shop, because it knows it will benefit. In other instances, the restaurant may accept an offer of media spend from the coffee shop and run the coffee shop ad in its own advertising chain, as a means of increasing foot traffic.

FIG. 7 is a flow diagram illustrating the advertisement arbitrage of the system. At step 701 the network introduces a proposed offer (e.g. advertisement) with attached media spend. The offer is reviewed not only by publisher members, but by merchant, company, and advertiser members. At step 702 the proposed offer is reviewed by a company. The system contemplates the ability to automate this process as well. A company may define a filter to look for specific types and/or locations of offers that the company believes it may benefit from. If the offer matches parameters at step 703, the system proceeds to step 704 and the company accepts the offer. At step 705 the company uses the media spend to place the offer in its own advertising chain or platform.

If the offer does not match parameters at step 703, the system may send it for manual review at step 706. At decision block 707 the company decides if there is interest and if so, proceeds to step 704. If not, the system returns to step 701.

Embodiment of Computer Execution Environment (Hardware)

An embodiment of the system can be implemented as computer software in the form of computer readable program code executed in a general purpose computing environment such as environment 500 illustrated in FIG. 5, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 510 and mouse 511 are coupled to a system bus 518. The keyboard and mouse are for introducing user input to the computer system and communicating that user input to central processing unit (CPU 513. Other suitable input devices may be used in addition to, or in place of, the mouse 511 and keyboard 510. I/O (input/output) unit 519 coupled to bi-directional system bus 518 represents such I/O elements as a printer, A/V (audio/video) I/O, etc.

Computer 501 may include a communication interface 520 coupled to bus 518. Communication interface 520 provides a two-way data communication coupling via a network link 521 to a local network 522. For example, if communication interface 520 is an integrated services digital network (ISDN) card or a modem, communication interface 520 provides a data communication connection to the corresponding type of telephone line, which comprises part of network link 521. If communication interface 520 is a local area network (LAN) card, communication interface 520 provides a data communication connection via network link 521 to a compatible LAN. Wireless links are also possible. In any such implementation, communication interface 520 sends and receives electrical, electromagnetic or optical signals which carry digital data streams representing various types of information.

Network link 521 typically provides data communication through one or more networks to other data devices. For example, network link 521 may provide a connection through local network 522 to local server computer 523 or to data equipment operated by ISP 524. ISP 524 in turn provides data communication services through the world wide packet data communication network now commonly referred to as the “Internet” 525 Local network 522 and Internet 525 both use electrical, electromagnetic or optical signals which carry digital data streams. The signals through the various networks and the signals on network link 521 and through communication interface 520, which carry the digital data to and from computer 500, are exemplary forms of carrier waves transporting the information.

Processor 513 may reside wholly on client computer 501 or wholly on server 526 or processor 513 may have its computational power distributed between computer 501 and server 526. The processing functionality can be provided via cloud servers or cloud processing systems. Server 526 symbolically is represented in FIG. 5 as one unit, but server 526 can also be distributed between multiple “tiers”. In one embodiment, server 526 comprises a middle and back tier where application logic executes in the middle tier and persistent data is obtained in the back tier. In the case where processor 513 resides wholly on server 526, the results of the computations performed by processor 513 are transmitted to computer 501 via Internet 525, Internet Service Provider (ISP) 524, local network 522 and communication interface 520. In this way, computer 501 is able to display the results of the computation to a user in the form of output.

Computer 501 includes a video memory 514, main memory 515 and mass storage 512, all coupled to bi-directional system bus 518 along with keyboard 510, mouse 511 and processor 513.

As with processor 513, in various computing environments, main memory 515 and mass storage 512, can reside wholly on server 526 or computer 501, or they may be distributed between the two. Examples of systems where processor 513, main memory 515, and mass storage 512 are distributed between computer 501 and server 526 include thin-client computing architectures and other personal digital assistants, Internet ready cellular phones and other Internet computing devices, and in platform independent computing environments, In other embodiments, memory and/or storage may reside, in whole or in part, in a cloud system.

The mass storage 512 may include both fixed and removable media, such as magnetic, optical or magnetic optical storage systems or any other available mass storage technology. The mass storage may be implemented as a RAID array or any other suitable storage means. Bus 518 may contain, for example, thirty-two address lines for addressing video memory 514 or main memory 515. The system bus 518 also includes, for example, a 32-bit data bus for transferring data between and among the components, such as processor 513, main memory 515, video memory 514 and mass storage 512. Alternatively, multiplex data/address lines may be used instead of separate data and address lines.

In one embodiment of the invention, the processor 513 is a microprocessor such as manufactured by Intel, AMD, Sun, etc. However, any other suitable microprocessor or microcomputer may be utilized. Main memory 515 is comprised of dynamic random access memory (DRAM). Video memory 514 is a dual-ported video random access memory. One port of the video memory 514 is coupled to video amplifier 516. The video amplifier 516 is used to drive the cathode ray tube (CRT) raster monitor 517. Video amplifier 516 is well known in the art and may be implemented by any suitable apparatus. This circuitry converts pixel data stored in video memory 514 to a raster signal suitable for use by monitor 517. Monitor 517 is a type of monitor suitable for displaying graphic images.

Computer 501 can send messages and receive data, including program code, through the network(s), network link 521, and communication interface 520. In the Internet example, remote server computer 526 might transmit a requested code for an application program through Internet 525, ISP 524, local network 522 and communication interface 520. The received code maybe executed by processor 513 as it is received, and/or stored in mass storage 512, or other non-volatile storage for later execution. In this manner, computer 500 may obtain application code in the form of a carrier wave. Alternatively, remote server computer 526 may execute applications using processor 513, and utilize mass storage 512, and/or video memory 515. The results of the execution at server 526 are then transmitted through Internet 525, ISP 524, local network 522 and communication interface 520. In this example, computer 501 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. An offer sharing system comprising:
in a processing system;
an offering network member defining an offer and defining an attached media spend associated with the offer;
a receiving network member accepting the offer and receiving the associated media spend when the receiving network member publishes the offer.

2. The system of claim 1 wherein the media spend includes a defined minimum format of publishing the offer.

3. The system of claim 1 wherein the offer is a daily deal.

4. The system of claim 1 wherein the media spend includes a defined maximum amount of spend.

5. The system of claim 1 wherein the media spend includes reciprocal ad space on a platform of the offering network member.

6. The system of claim 1 wherein the media spend is automatically generated by the offering network member.

7. The system of claim 6 wherein the automatic generation of the media spend is based on goals of the offering network member of performance of the offer.

8. The system of claim 7 wherein the automatic generation of the media spend includes a cost of the media spend.

9. The system of claim 8 wherein the cost of the media spend is below a budgeted cost determined by the offering network member.
